(19) United States
(12) Patent Application Publication
(10) Pub. No.: US 2015/0185793 A1
(43) Pub. Date: Jul. 2, 2015

(54) HEAT DISSIPATION STRUCTURE OF MOBILE DEVICE

(71) Applicant: Asia Vital Components Co., Ltd., New Taipei City (TW)

(72) Inventors: Kuo-Chun Hsieh, New Taipei City (TW); Chuan-Chin Huang, New Taipei City (TW)

(73) Assignee: Asia Vital Components Co., Ltd., New Taipei City (TW)

(21) Appl. No.: 14/145,440

(22) Filed: Dec. 31, 2013

(51) Int. Cl. G06F 1/20

(52) U.S. Cl. CPC G06F 1/203; G06F 1/206

(57) ABSTRACT

A heat dissipation structure of mobile device includes a case and a heat generation component. The case defines a receiving space. The heat generation component is disposed in the receiving space. One face of the heat generation component is attached to one face of a cooling chip. The other face of the cooling chip is attached to the case. The cooling chip serves to absorb the heat generated by the heat generation component and conduct the heat to the case to dissipate the heat, whereby the heat dissipation problem of the mobile device is solved and an energy-saving effect is achieved.

### BACKGROUND OF THE INVENTION

1. Field of the Invention

The present invention relates generally to a heat dissipation structure, and more particularly to a heat dissipation structure applied to mobile device for enhancing the heat dissipation performance of the mobile device.

2. Description of the Related Art

In the development of electronic devices, there is a trend to develop processing chips with higher and higher operation performance and high operation clock. This leads to more heat dissipation problems. Moreover, there is a trend to develop lighter, thinner and smaller electronic devices with high operation performance. As a result, it has become a critical issue how to enhance heat dissipation efficiency of the electronic devices.

In operation or processing, the chips or processors inside an electronic device will generate residual heat to cause rise of temperature of the chips or processors themselves. With respect to a lightweight and thin mobile device such as an ultra-thin notebook, tablet, intelligent mobile phone or other handheld mobile device, conventionally, the case of the mobile device is simply perforated to dissipate the heat by way of conduction and thermal convection. However, such heat dissipation measure can hardly handle the high heat generated by the current high-performance chips or processors.

Along with the continuous promotion of the performance of the current handheld mobile devices, double-core, four-core and even higher performance central processing units have been developed for the handheld mobile devices. The higher the processing speed of the central processor is, the higher the heat generated by the central processor is. Therefore, it has become a very important topic how to quickly conduct and dissipate the heat of the mobile device with the same volume and thickness.

### SUMMARY OF THE INVENTION

It is therefore a primary object of the present invention to provide a heat dissipation structure of mobile device for enhancing the heat dissipation performance of the mobile device.

It is a further object of the present invention to provide the above heat dissipation structure of mobile device, which is applicable to a mobile device with a limited internal space for enhancing the heat dissipation performance of the mobile device.

It is still a further object of the present invention to provide the above heat dissipation structure of mobile device, which can be disposed in a limited space to conduct heat and effectively enhance the heat dissipation performance of the mobile device without increasing the thickness or total volume of the mobile device.

It is still a further object of the present invention to provide the above heat dissipation structure of mobile device, in which a cooling chip is used to not only dissipate the heat of the heat generation component, but also convert thermal energy into electrical energy to provide power for the mobile device.

To achieve the above and other objects, the heat dissipation structure of mobile device of the present invention includes a case and a heat generation component. The case includes an upper cover and a lower cover. The upper and lower covers are mated with each other to define a receiving space. The heat generation component is disposed in the receiving space. The heat generation component is disposed on one face of a circuit unit. A cooling chip is disposed on the other face of the heat generation component. The other face of the cooling chip, which face is distal from the circuit unit, is attached to the lower cover. Accordingly, one face of the cooling chip can absorb the heat of the heat generation component, while the other face of the cooling chip can conduct the heat to the lower cover to dissipate the heat. In this case, the heat dissipation problem of the mobile device is solved and an energy-saving effect is achieved. Moreover, the heat conduction structure can be disposed in a limited space to effectively enhance the heat dissipation performance of the mobile device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective exploded view of a first embodiment of the heat dissipation structure of mobile device of the present invention;

FIG. 1B is a perspective exploded view of the first embodiment of the heat dissipation structure of mobile device of the present invention, seen from another angle;

FIG. 1C is a perspective assembled view of the first embodiment of the heat dissipation structure of mobile device of the present invention;

FIG. 1D is a sectional assembled view of the first embodiment of the heat dissipation structure of mobile device of the present invention;

FIG. 2A is a perspective exploded view of a second embodiment of the heat dissipation structure of mobile device of the present invention;

FIG. 2B is a perspective exploded view of the second embodiment of the heat dissipation structure of mobile device of the present invention, seen from another angle;

FIG. 2C is a perspective assembled view of the second embodiment of the heat dissipation structure of mobile device of the present invention; and

FIG. 2D is a sectional assembled view of the second embodiment of the heat dissipation structure of mobile device of the present invention.

### DETAILED DESCRIPTION OF THE PREFERRED EMBODIMENTS

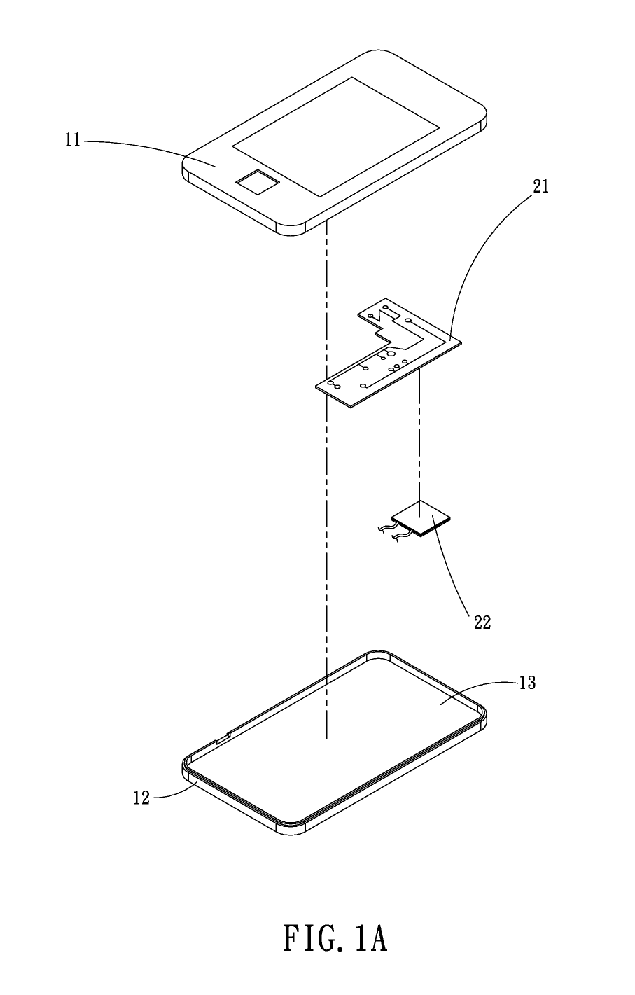

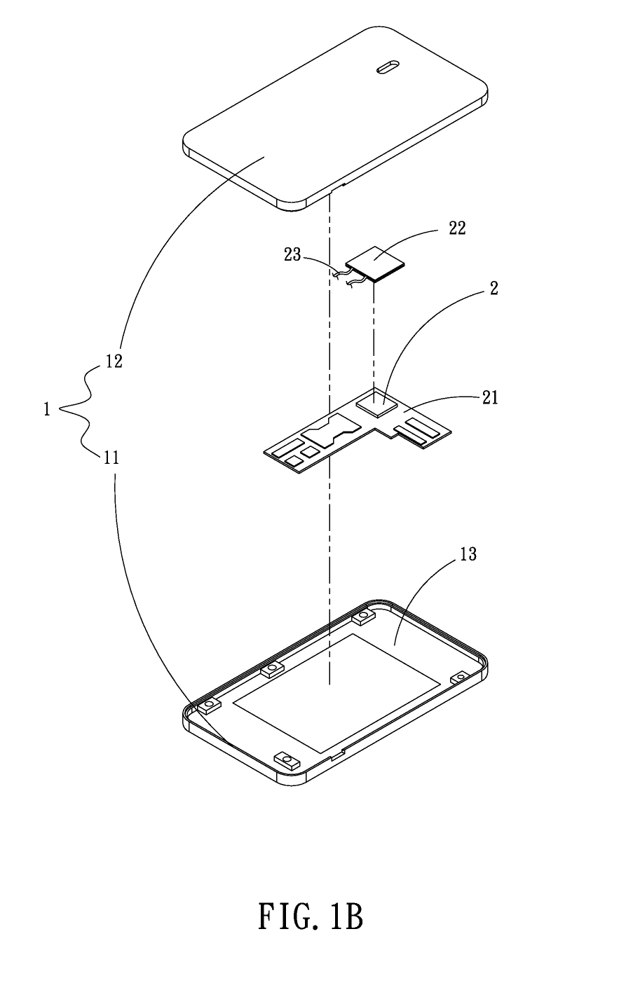

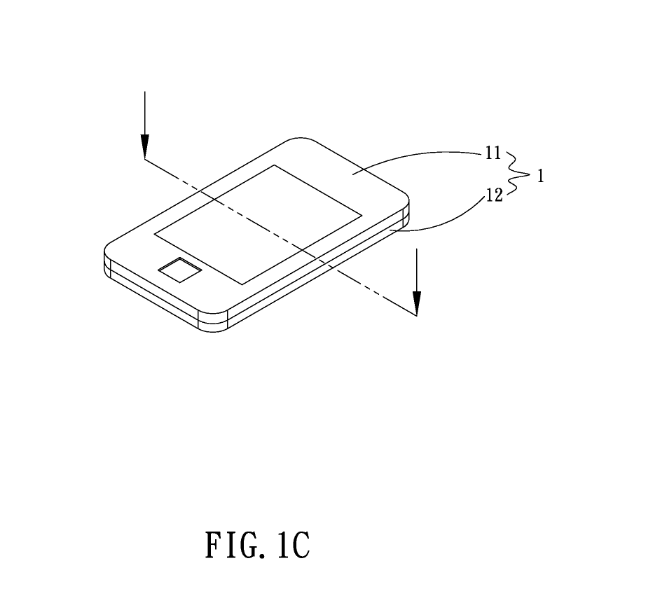

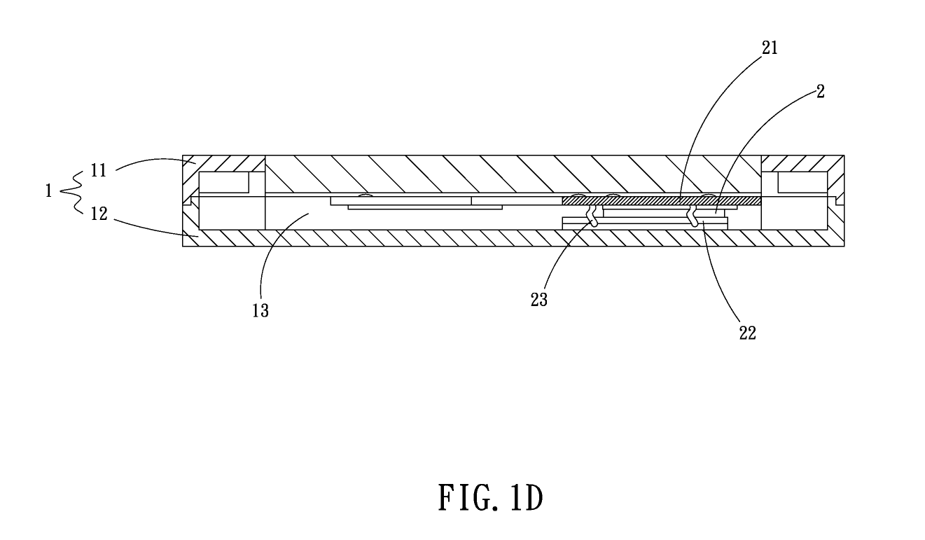

Please refer to FIGS. 1A to 1D. FIG. 1A is a perspective exploded view of a first embodiment of the heat dissipation structure of mobile device of the present invention. FIG. 1B is a perspective exploded view of the first embodiment of the heat dissipation structure of mobile device of the present invention, seen from another angle. FIG. 1C is a perspective assembled view of the first embodiment of the heat dissipation structure of mobile device of the present invention. FIG. 1D is a sectional assembled view of the first embodiment of the heat dissipation structure of mobile device of the present invention. According to the first embodiment, the heat dissipation structure of mobile device of the present invention includes a case 1 and a heat generation component 2.

The case 1 includes an upper cover 11 and a lower cover 12. The upper and lower covers 11, 12 are mated with each other to define a receiving space 13. The heat generation component 2 is disposed in the receiving space 13. The heat generation component 2 is disposed on one face of a circuit unit 21. The circuit unit 21 is correspondingly disposed in the receiving space 13. The upper cover 11 is correspondingly positioned on one face of the circuit unit 21. The heat generation component 2 is disposed on the other face of the circuit unit 21. One face of the heat generation component 2 is attached to and connected with the circuit unit 21. A cooling chip 22 is disposed on the other face of the heat generation component 2. The cooling chip 22 is also correspondingly disposed in the receiving space 13. The other face of the cooling chip 22, which face is distal from the heat generation component 2, is attached to the lower cover 12. When the heat generation component 2 generates heat, due to Peltier Effect, the heat of the heat generation component 2 can be conducted from one face of the cooling chip 22 to the other face of the cooling chip 22, which face is attached to the lower cover 12. Accordingly, one face of the cooling chip 22 absorbs the heat of the heat generation component 2, while the other face of the cooling chip 22 conducts the heat to the lower cover 12 to dissipate the heat. In this case, the heat dissipation problem of the mobile device is solved. Moreover, the heat conduction structure can be disposed in a limited space to effectively enhance the heat dissipation performance of the mobile device.

The cooling chip 22 has at least one connection wire 23 electrically connected to the circuit unit 21. When one face of the cooling chip 22 absorbs the heat of the heat generation component 2, while the other face of the cooling chip 22 conducts the heat to the lower cover 12 to dissipate the heat, energy conversion also takes place to convert the thermal energy into electrical energy and provide power to the circuit unit 21. Accordingly, the energy resource is saved.

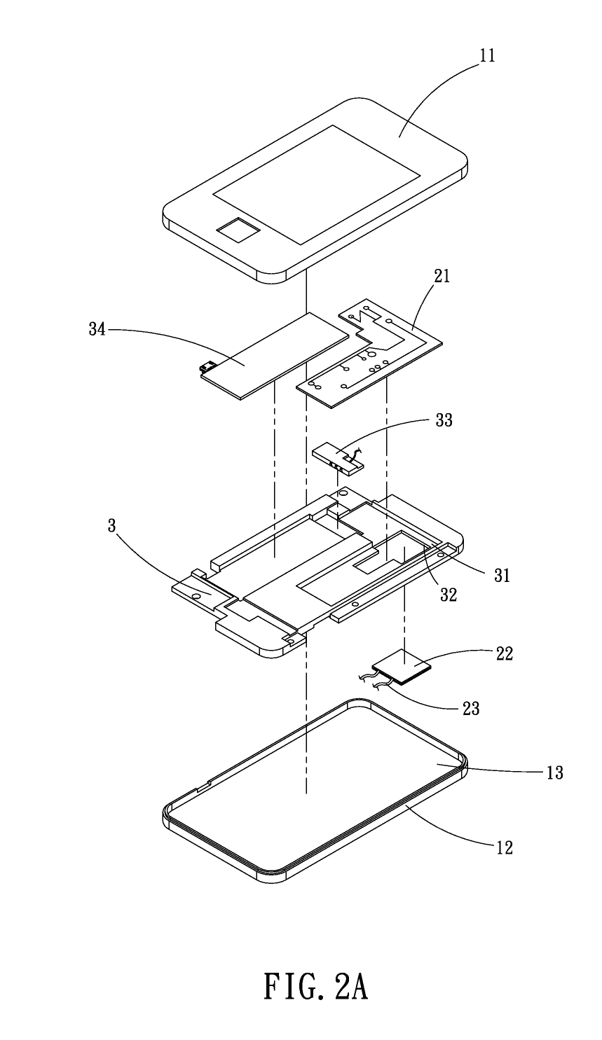

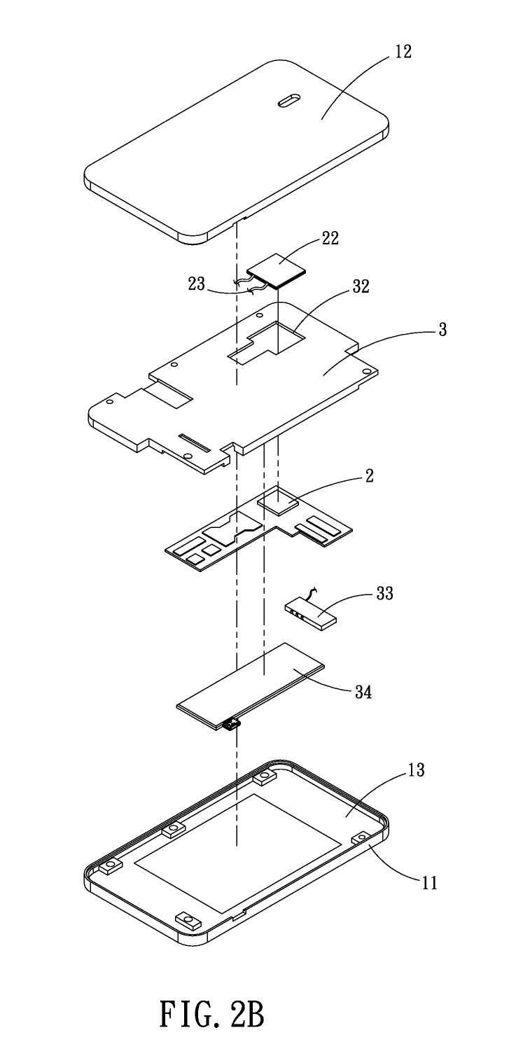

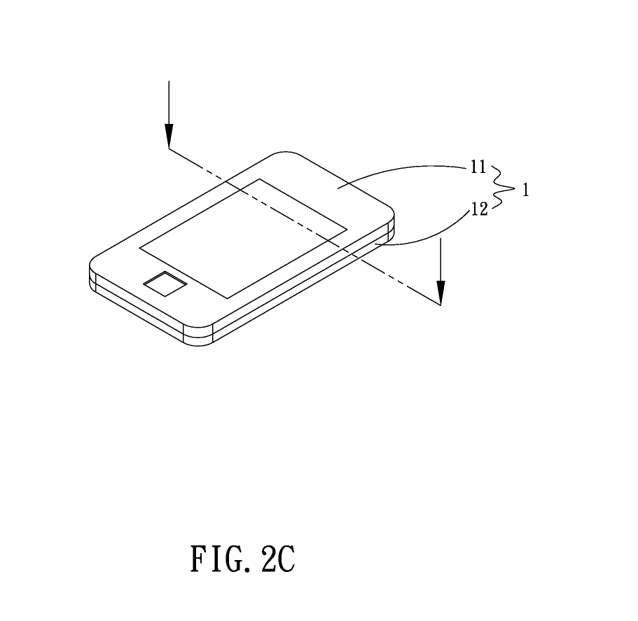

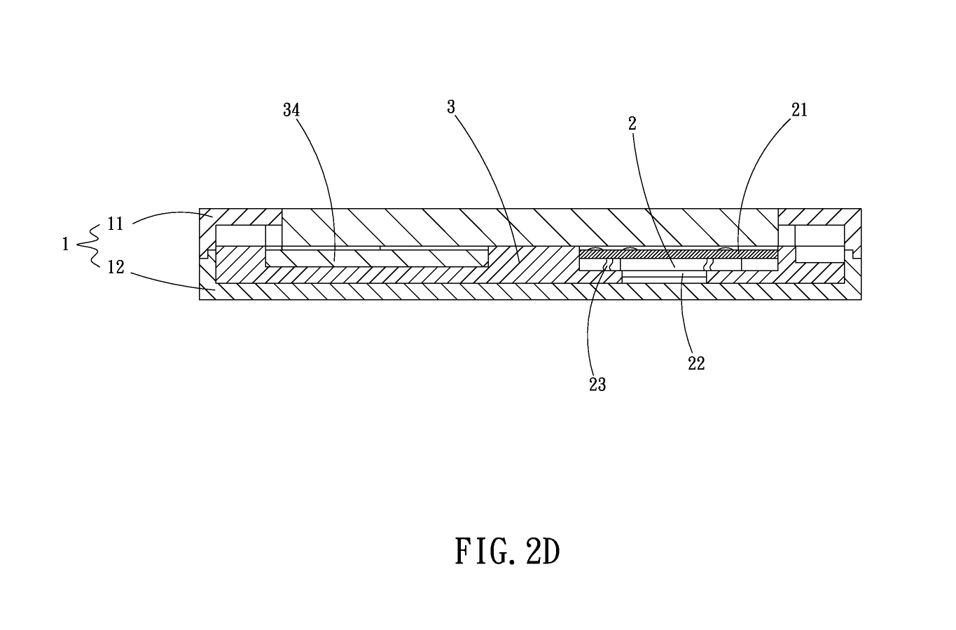

Please now refer to FIGS. 2A to 2D. FIG. 2A is a perspective exploded view of a second embodiment of the heat dissipation structure of mobile device of the present invention. FIG. 2B is a perspective exploded view of the second embodiment of the heat dissipation structure of mobile device of the present invention, seen from another angle. FIG. 2C is a perspective assembled view of the second embodiment of the heat dissipation structure of mobile device of the present invention. FIG. 2D is a sectional assembled view of the second embodiment of the heat dissipation structure of mobile device of the present invention. The second embodiment is partially identical to the first embodiment in structure and thus will not be repeatedly described hereinafter. The second embodiment is different from the first embodiment in that at least one support body 3 is further disposed in the receiving space 13. The support body 3 is formed with a first receptacle 31 and a second receptacle 32 in positions respectively corresponding to the circuit unit 21 and the cooling chip 22. An adapter unit 33 is further disposed on the support body 3 for connecting with a power source 34. The support body 3 is disposed in the receiving space 13. The circuit unit 21 is disposed in the first receptacle 31. The heat generation component 2 is disposed on one face of the circuit unit 21 and the cooling chip 22 is attached to the heat generation component 2. The heat generation component 2 and the cooling chip 22 are disposed in the second receptacle 32. One face of the cooling chip 22 absorbs the heat of the heat generation component 2, while the other face of the cooling chip 22 conducts the heat to the lower cover 12 to dissipate the heat. In this case, the heat dissipation problem of the mobile device is solved. Moreover, the heat conduction structure can be disposed in a limited space to effectively enhance the heat dissipation performance of the mobile device without increasing the thickness or total volume of the mobile device.

The adapter unit 33 disposed on the support body 3 is electrically connected to the circuit unit 21. The power source 34 is assembled and connected with the adapter unit 33 and electrically connected to the circuit unit 21. The connection wire 23 of the cooling chip 22 is electrically connected to the circuit unit 21. Accordingly, when one face of the cooling chip 22 absorbs the heat of the heat generation component 2, while the other face of the cooling chip 22 conducts the heat to the lower cover 12 to dissipate the heat, energy conversion also takes place to convert the thermal energy into electrical energy and provide power to the circuit unit 21 and the power source 34 so as to save energy resource.

The present invention has been described with the above embodiments thereof and it is understood that many changes and modifications in the above embodiments can be carried out without departing from the scope and the spirit of the invention that is intended to be limited only by the appended claims.

What is claimed is:

1. A heat dissipation structure of mobile device, comprising:
a case including an upper cover and a lower cover, the upper and lower covers being mated with each other to define a receiving space; and
a heat generation component disposed on a circuit unit and correspondingly disposed in the receiving space, a cooling chip being disposed on one face of the heat generation component, the other face of the cooling chip being attached to the lower cover.

2. The heat dissipation structure of mobile device as claimed in claim 1, wherein the cooling chip has at least one connection wire electrically connected to the circuit unit.

3. The heat dissipation structure of mobile device as claimed in claim 2, wherein the cooling chip is electrically connected to the circuit unit to supply power to the circuit unit.

4. The heat dissipation structure of mobile device as claimed in claim 1, wherein the at least one support body is further disposed in the receiving space.

5. The heat dissipation structure of mobile device as claimed in claim 4, wherein the support body is formed with a first receptacle in which the circuit unit is disposed.

6. The heat dissipation structure of mobile device as claimed in claim 4, wherein the support body is formed with a second receptacle in which the cooling chip is disposed.

7. The heat dissipation structure of mobile device as claimed in claim 4, wherein at least one power source is further disposed in the receiving space, the power source being disposed on the support body and electrically connected to the circuit unit and the cooling chip via an adapter unit.
